(19) United States
(12) Patent Application Publication
(10) Pub. No.: US 2016/0037250 A1
(43) Pub. Date: Feb. 4, 2016

(54) Earphone Storage Device

(71) Applicant: Mark D. HILDEBRANDT, (US)

(72) Inventor: Mark D. Hildebrandt, Saline, MI (US)

(21) Appl. No.: 14/777,105

(22) PCT Filed: Mar. 14, 2014
(86) PCT No.: PCT/US14/27632

§ 371 Date: Sep. 15, 2015

Related U.S. Application Data
(60) Provisional application No. 61/790,224, filed on Mar. 15, 2013.

(51) Int. Cl. H04R 1/10; B65H 75/06; B65H 75/28

(52) U.S. Cl. CPC H04R 1/1033; B65H 75/285; B65H 75/06; B65H 2701/3919; B65H 2701/50

(57) ABSTRACT

A device for securing ear bud style headphones includes a main body and a pair of grommets coupled to the main body. The grommets include a flexible entry portion that defines an aperture through which a head portion of the headphones can be inserted into a cavity of the grommet. A cord portion of the head-phones can be wrapped around the main body and an end of the cord portion can be inserted into a slot.

### CROSS-REFERENCE TO RELATED APPLICATIONS

This application claims the benefit of U.S. Provisional Application No. 61/790,224, filed Mar. 15, 2013, which is hereby incorporated by reference in its entirety.

### FIELD OF THE INVENTION

This application relates to an electronics storage device and, more particularly, a storage device for ear bud style headphones.

### BACKGROUND

Ear bud style headphones are well known in the art. Various types of ear bud style headphones include a pair of ear buds that each include a generally hard plastic housing that includes the speaker therein, with a highly flexible left or right cord that extends from the housing toward a main cord, where the left and right cords combine. The housing can include a hard or soft ear portion that fits into a user's ears to provide audio. The main cord includes a mini-jack male connector that is configured to mate with a corresponding female connector on a portable audio device.

These ear buds have become popular due their inclusion with various portable audio devices. They are also generally inexpensive and readily replaceable and interchangeable between various audio devices. Another feature of these ear bud style headphones is their easy portability, where the ear buds can be stored in a user's pocket, purse, or the like while occupying a small amount of space.

However, the highly flexible nature of the left and right cords, as well as the main cord, can cause the ear buds to become easily tangled, which is undesirable.

### BRIEF DESCRIPTION OF THE DRAWINGS

FIG. 1 shows an ear bud securement device having a main body and a pair of grommets coupled thereto, wherein the grommets include an entry portion defining an aperture;

FIGS. 2A-2D illustrate a method for attaching a set of ear buds to the device;

FIGS. 3A-3E illustrate the body portion without grommets installed and alternative shapes for the main body;

FIGS. 4A-4F illustrate additional alternative shapes for the main body;

FIGS. 5-16 illustrate various embodiments of the device, showing various entry portions and apertures; and

FIG. 17 is a cross-sectional view of a grommet having a closed endwall.

### DETAILED DESCRIPTION OF THE PREFERRED EMBODIMENTS

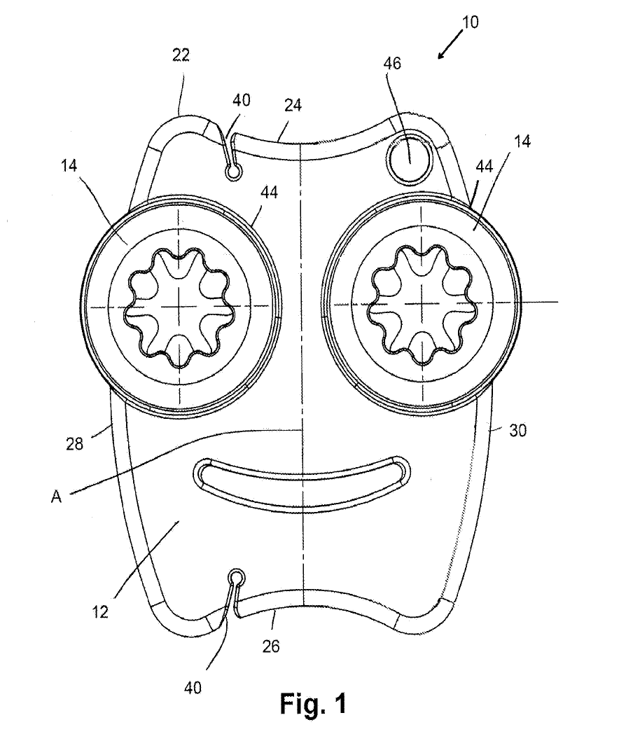

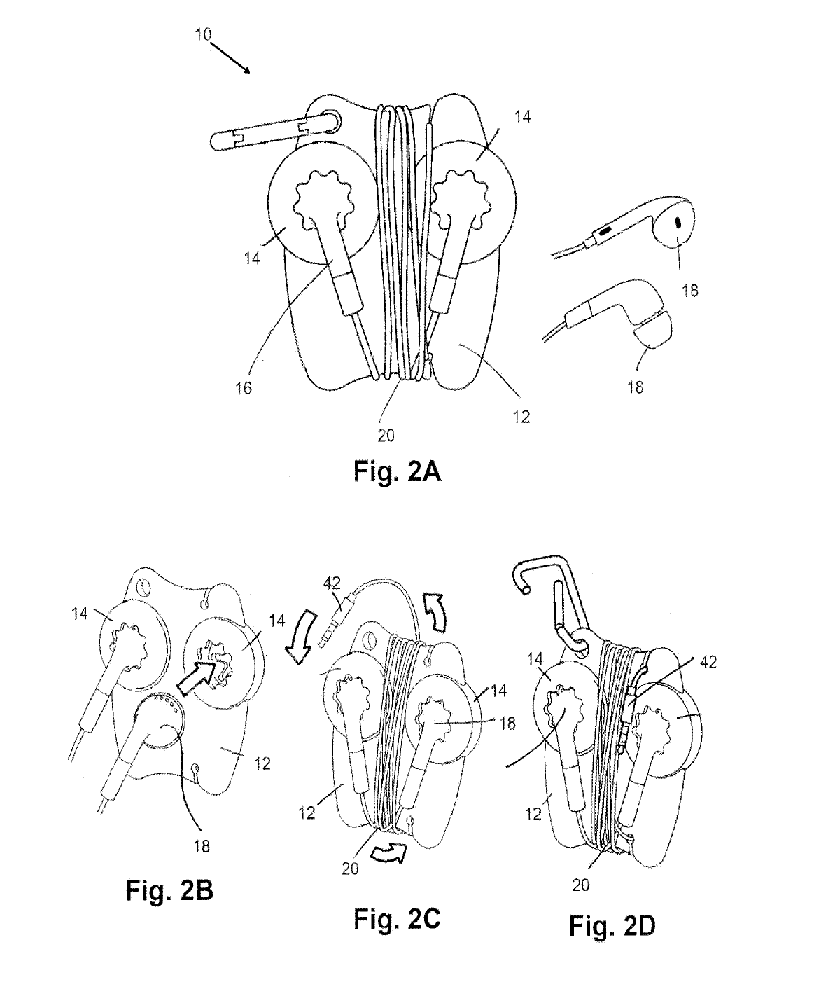

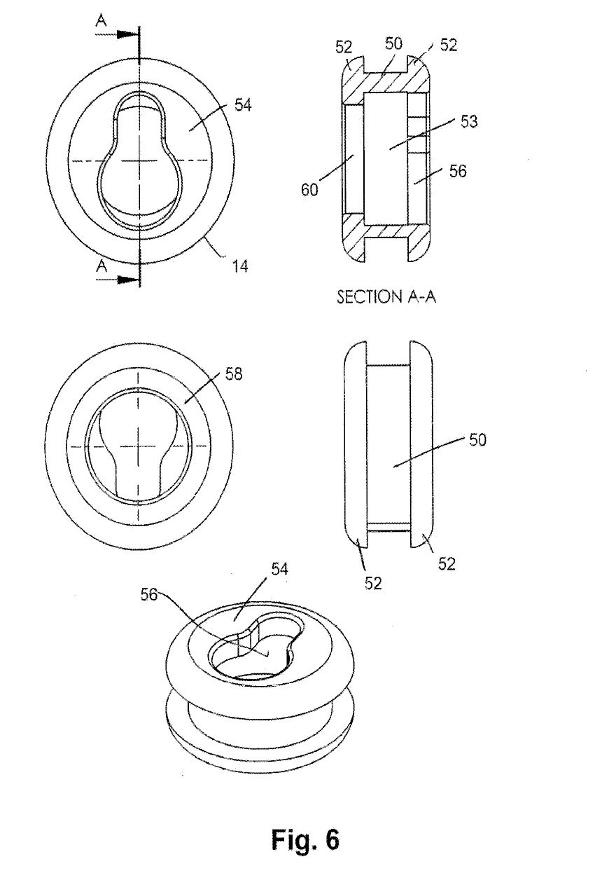

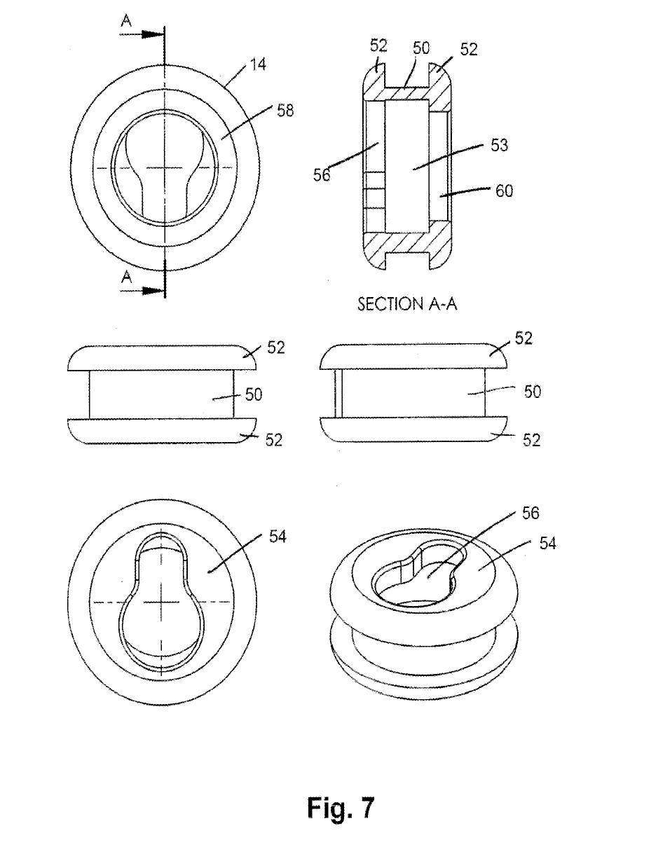

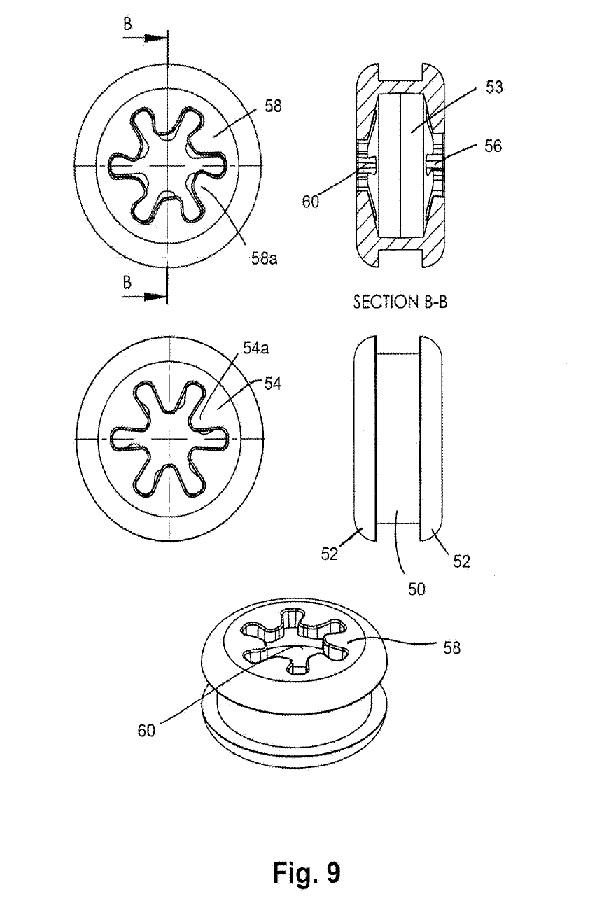

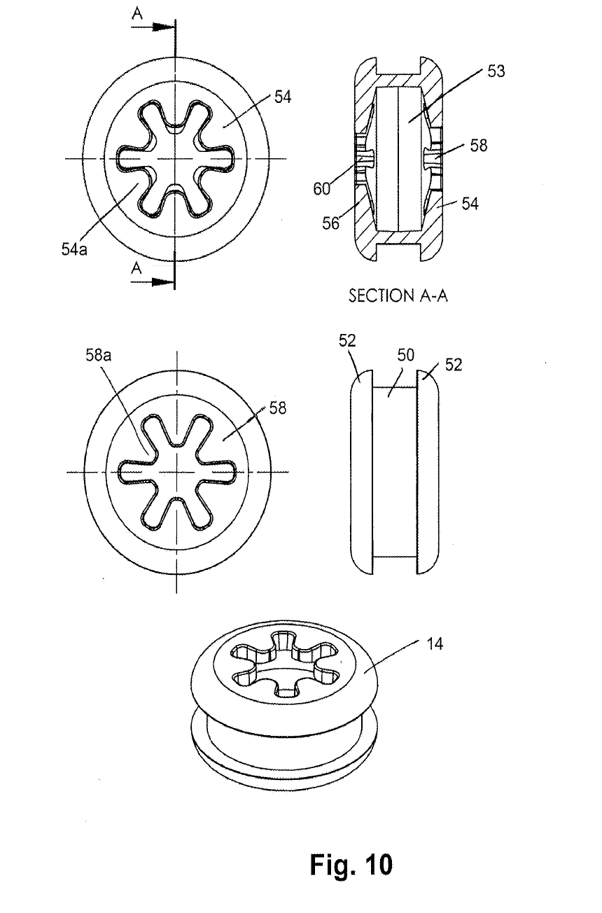

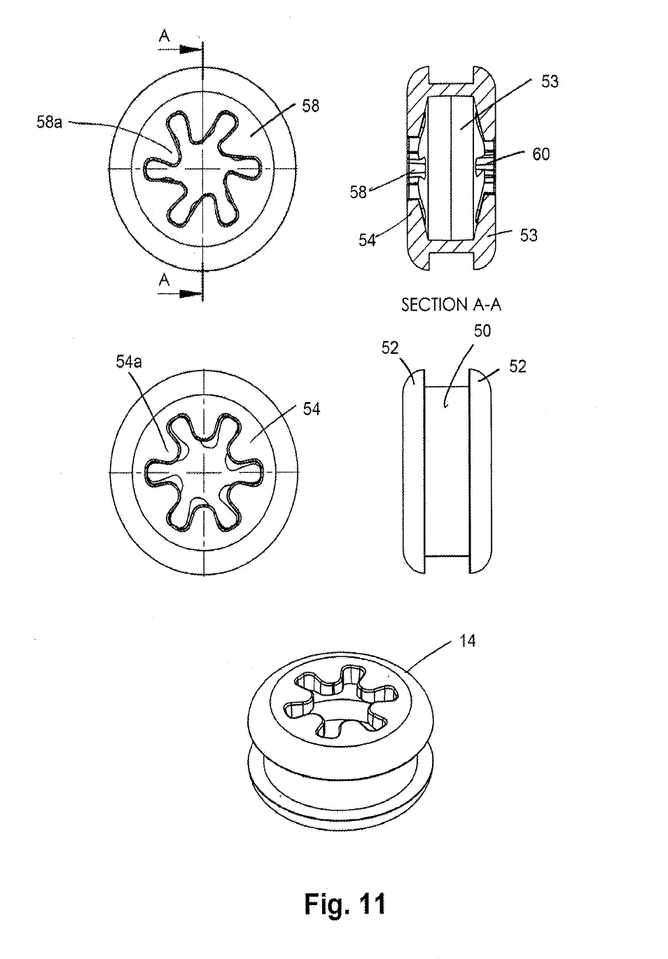

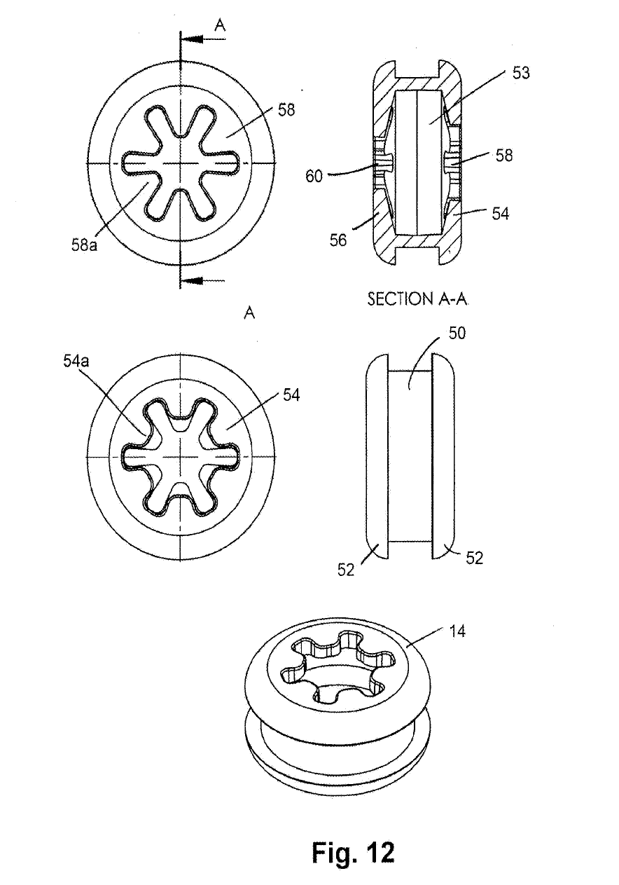

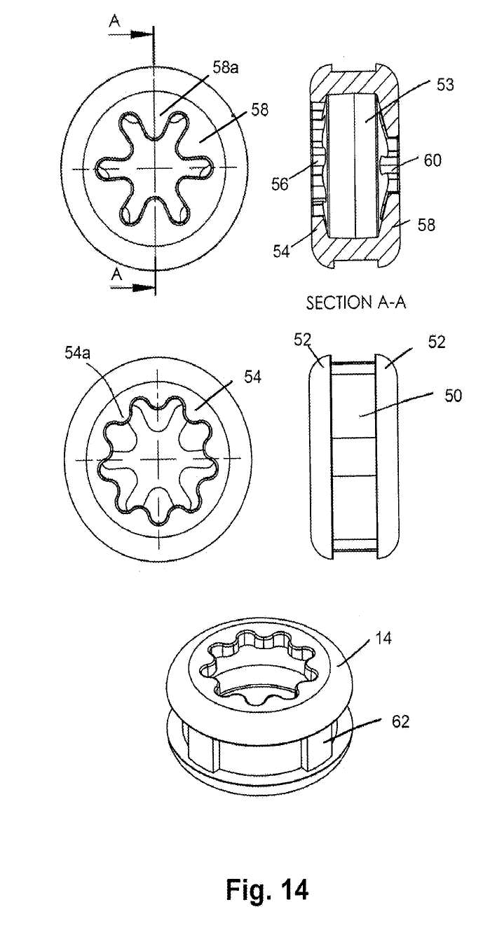

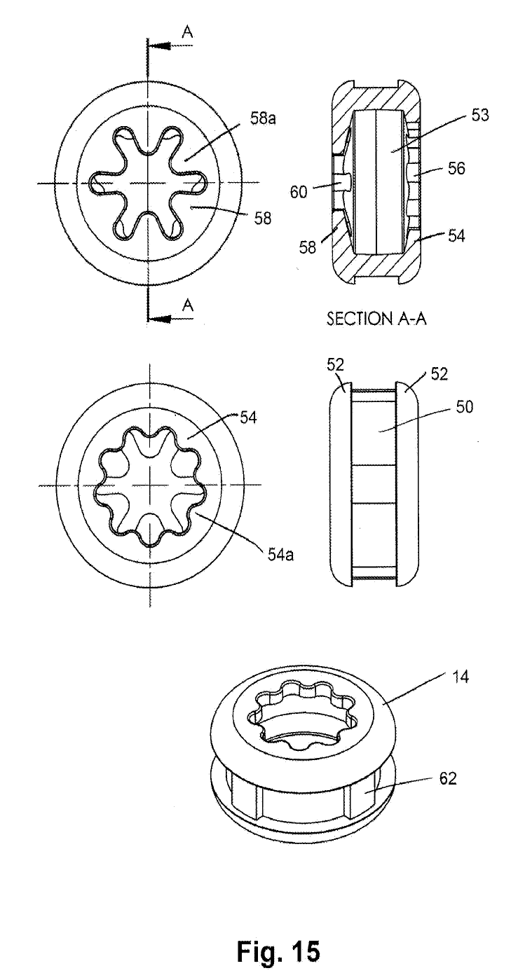

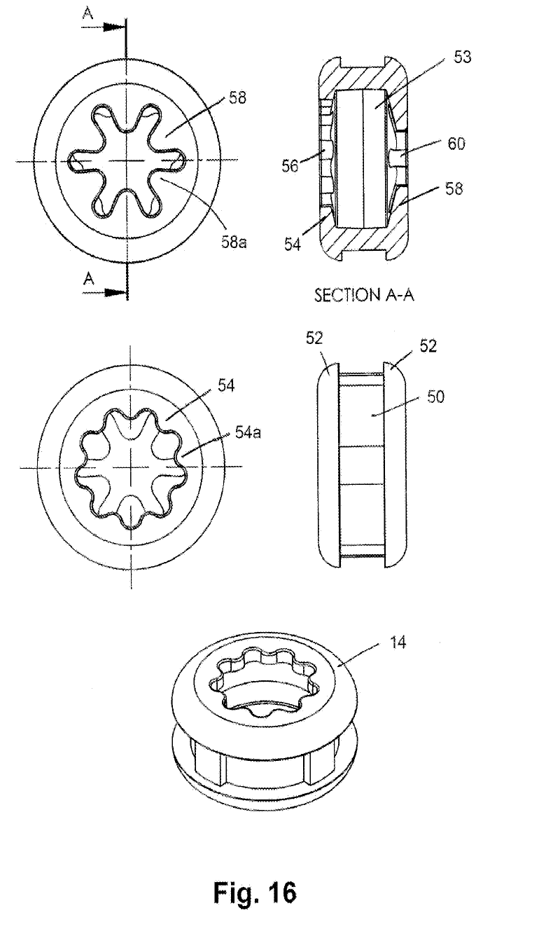

With reference to FIGS. 1-17, an ear bud securement device 10 is provided having a main body 12 and a pair of grommets 14 coupled thereto. The device 10 is sized configured to allow for ear bud-style headphones 16 having a pair of head portions 18 and a cord portion 20 to be secured and wrapped therearound, as shown in FIGS. 2A-2D, as further described below. More specifically, the head portions 18 of the headphones 16 can be inserted into and secured by the grommets 14, and the cord portion 20 can be wrapped around the body 12.

With reference to FIG. 1, the body 12 can have a generally flat shape with an outer profile 22. The outer profile 22 can include a first concave edge 24, a second concave edge 26, a first convex edge 28, and a second convex edge 30. The concave edges 24, 26 are on opposite sides of the body 12, and the convex edges 28, 30 are on opposite sides of the body 12.

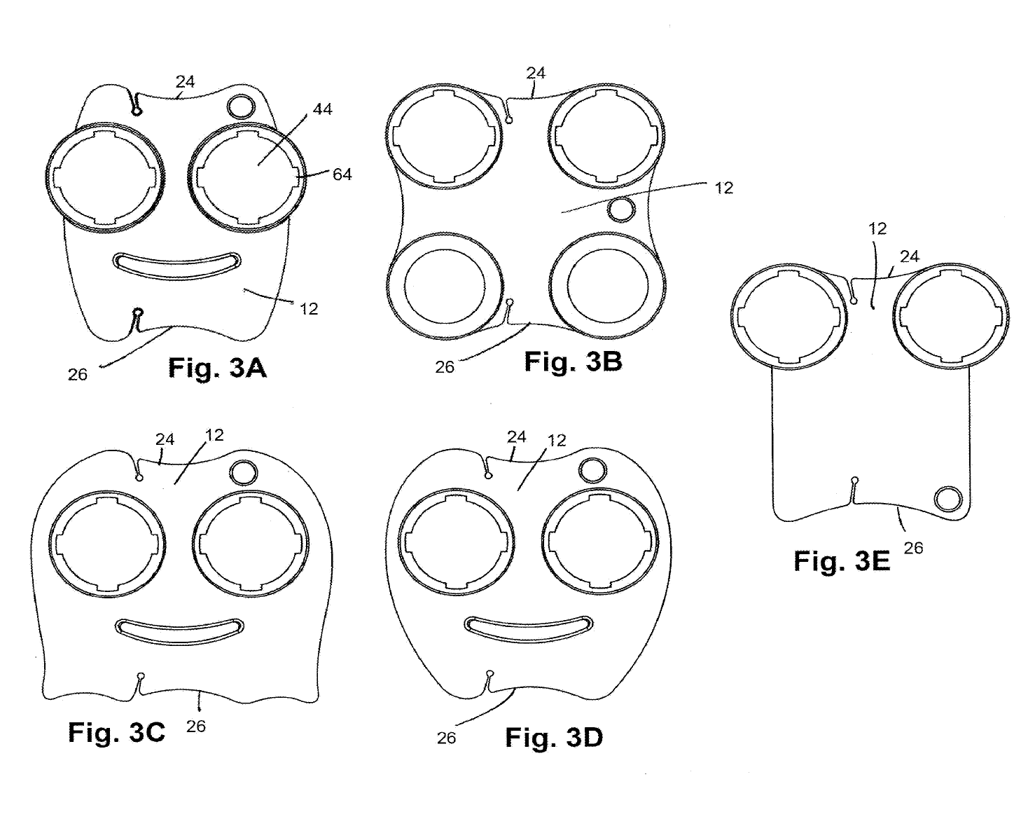

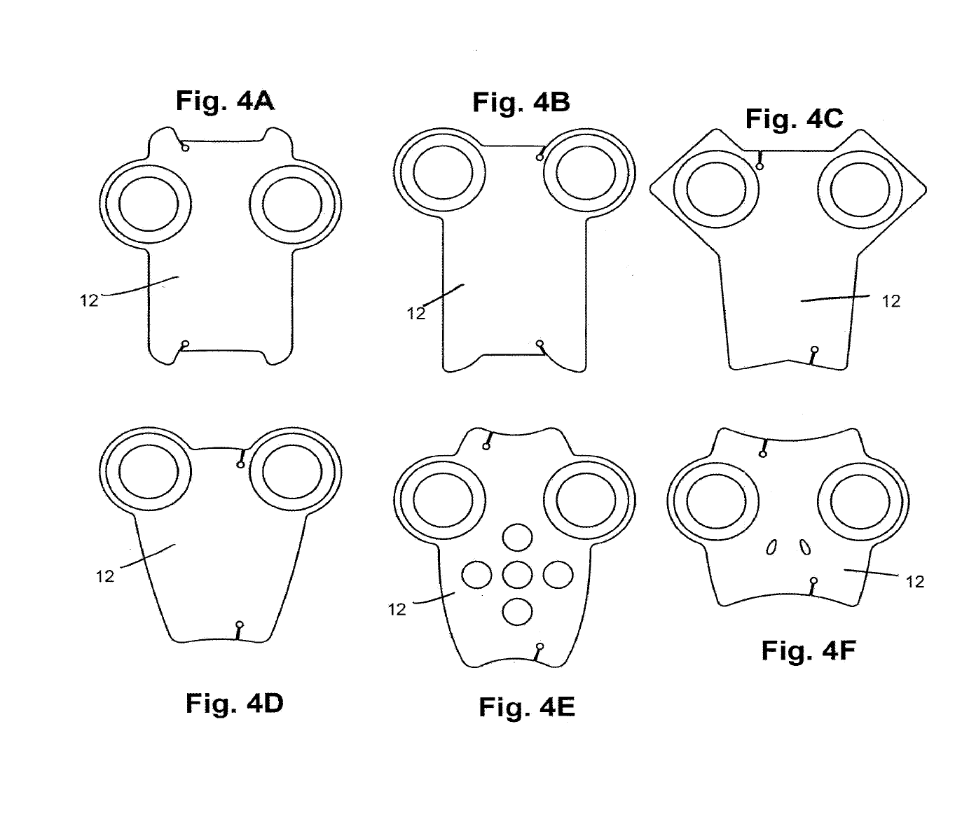

However, as shown in FIGS. 3A-3E, the body 12 can have various other shapes to go along with the concave edges 24 and 26. Other shapes of the body 12 are shown in FIGS. 4A-4F. In some forms, the body 12 can have an outer profile 22 without concave edges.

The body 12 defines a central longitudinal axis A, with the concave edges 224, 26 centered thereon. In one form, the distance between the concave edges 24 and 26, as measured along the axis A, is approximately 2.38 inches, and the outer distance between the concave edges 24, 26 is approximately 2.69 inches, such that the depth of the concavity for edge 24 is approximately 0.16 inches and the depth of concavity for edge 26 is approximately 0.15 inches.

The above sizing corresponds to a preferred sizing for securing Apple brand ear bud-style headphones 16 that are typically supplied with Apple's iPod and iPhone products. These headphones 16 can include an in-line volume control and microphone portion (not shown) disposed at a predetermined location. The above preferred sizing is arranged so that the microphone portion will lay generally flat against the body 12 and preferably not be disposed at one of the edges 24 or 26 when wrapped. It will be appreciated that similar sizing can be determined to correspond to other headphone brands, as well, although many other brands use sizing similar to the Apple brand sizing.

The body 12 can further include a slot portion 40 disposed at each of the concave edges 24, 26. The slot portion 40 will extend into the body 12, allowing a terminal portion 42 (FIGS. 2C and 2D) of the headphones 16 to be inserted and secured therein after being wrapped.

The body 12 also includes a pair of holes or openings 44 that are sized and configured to receive and secure the grommets 14, which are further described below. The grommets 14 are preferably secured to the body 12 in an interlocking connection to prevent turning, provide a secure fit, and provide a desired orientation.

When the grommets 14 are installed, they are disposed on each side of the axis A and approximately 0.83 inches, as measured along the axis A, from the inner portion of the concave edge 24, and approximately 1.55 inches, as measured along the axis A, from the concave edge 26.

The body 12 is preferably made from a generally rigid but slightly flexible and resilient material, such as a molded plastic, with sufficient rigidity to provide support to the headphones 16 when they are wrapped around the body 12. The body can include key-ring hole 46 for easy attachment to a key ring or similar apparatus.

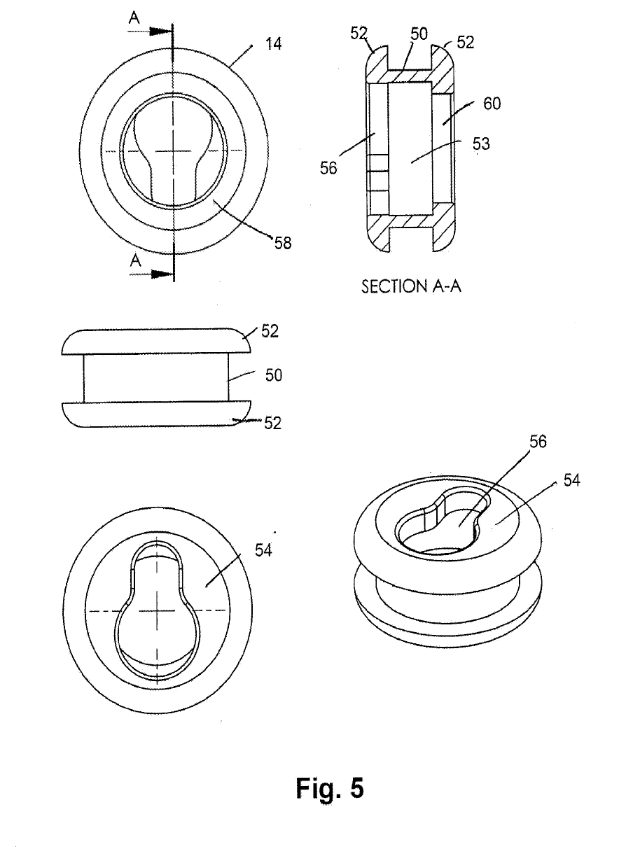

With reference now to FIGS. 5-17, the grommets 14 can have various shapes and sizes shown in the Figures. With reference to FIGS. 5-7, the grommet 14 can have a generally round shape, with a main body portion 50 and a pair of flange portions 52. The main body portion 50 defines a cavity 53 therein. The main body portion 50 is sized to correspond to the openings 44 in the body 12. The flanges 52 will overlap front and back surfaces of the body 12 when the grommets 14 are coupled to the body 12.

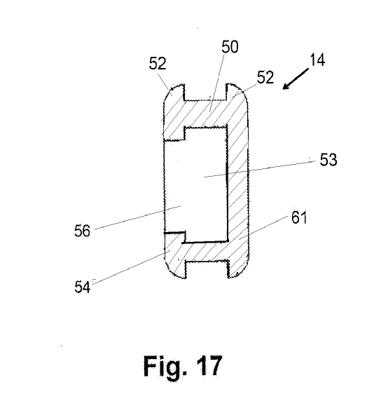

The grommets 14 further include a first entry portion 54 that defines an aperture 56. The grommets can further include a second entry portion 58, on the opposite side from the first entry portion. The second entry portion 58 can include a second aperture 60. Alternatively, instead of the second entry portion 58, the grommet can include a closed wall portion 61 (FIG. 17) for added protection to the headphones.

The entry portion 54 and 58 can be made from a flexible material, such as rubber, silicone, foam, or the like. The flexible nature of the entry portion 54 and 58 will allow the head portion 18 of the headphones 16 to be inserted through the aperture 56 or 60 for securement by the grommet 14. The apertures 56 and 60 can have various shapes, as shown throughout FIGS. 1-17. In one form, the aperture 56 can have a keyhole shape, as shown in FIGS. 5-7, and the aperture 60 can have a generally circular shape, as shown in FIG. 5-7.

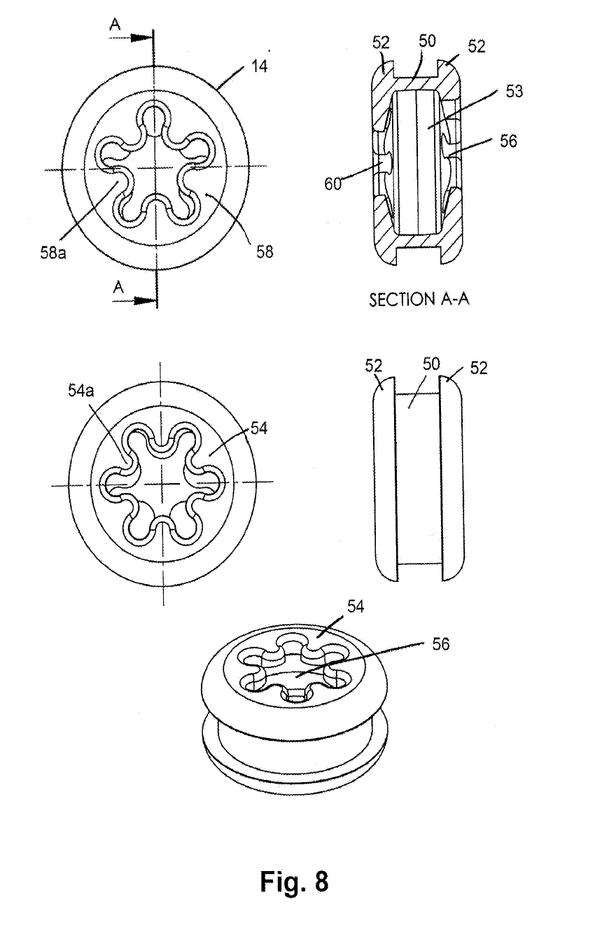

With reference to FIGS. 8-16, the entry portions 54 and 58 can include finger portions 54a or 58a, respectively. The finger portions 54a and 58a can define various non-circular shaped apertures 56 or 60. Accordingly, the apertures could have a star shape, asterisk shape, spline shape, or the like.

The constricting shapes of the apertures 56, 60 relative to the larger cavity 53 allows for the head portion 18 of the headphones 16 to be securely held within the grommet 14. The aperture 56 can be generally larger than the aperture 60 to allow for insertion of various types of head portions. For example, the Apple brand headphones 56 may require a larger aperture than a silicone style ear bud. The two-side configuration of the grommet 14 therefore provides a robust and adaptable solution for a variety of headphone brands. However, in some forms, the aperture 56 and 60 can be the same size.

Additionally, as stated above, the grommets 14 can include the wall portion 61, instead of an entry portion and aperture, to close off one side of the grommet 14, thereby keeping attached headphones 16 clean, protected, and secured.

The material of the entry portions 54, 58 is preferably softer than the body portion 50, thereby allowing for easy insertion of the headphones 16 into the cavity 53 of the main body portion 50. The relatively harder main body portion 50 can provide added protection relative to a softer material.

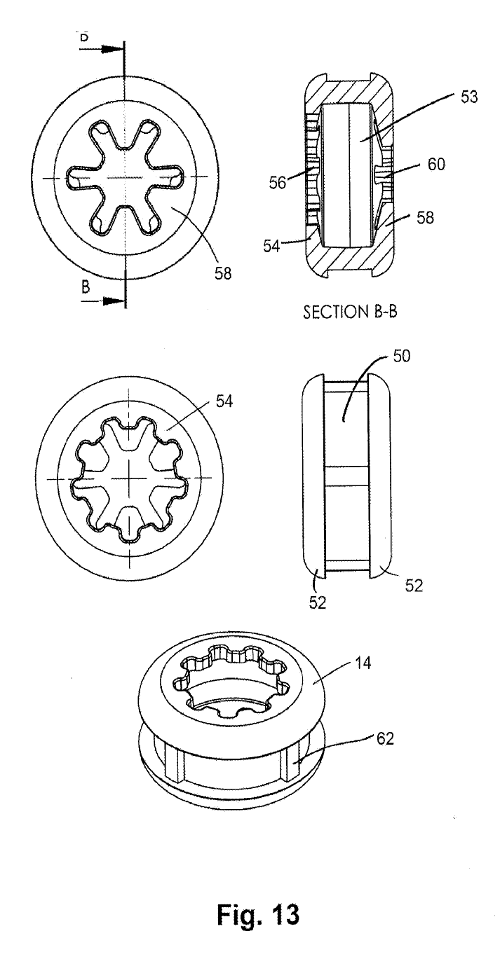

In one form, as shown in FIGS. 13-16, main body portion 50 can include one or more rib members 62 that can cooperate with corresponding slots 64 (FIG. 3A) in the main body 12 to assist in limiting the grommets 14 from rotating when secured to the body 12. In another form, the grommets 14 can be integrally formed with the main body 12.

To use the device 10, the headphones 16 are inserted into the apertures 48 or 58 of grommets 14. The cord 20 is then wrapped around the body 12. After wrapping the cord 20, the end 42 of the cord can be inserted into the slot portion 40 and secured. To remove the headphones 16, the cord is unwrapped and the head portions are removed from the cavity 53 of the grommet 14.

While the above description constitutes the preferred embodiment of the present invention, it will be appreciated that the invention is susceptible to modification, variation and change without departing from the proper scope and fair meaning of the accompanying claims.

What is claimed is:

1. A device for storing ear bud-style headphones, the device comprising:
a main body; and
at least one grommet coupled to the main body, the at least one grommet having a body portion defining a cavity therein and at least one entry portion having an aperture therethrough providing access to the cavity.

2. The device of claim 1, wherein the at least one grommet comprises a pair of grommets.

3. The device of claim 1, wherein the main body includes an outer edge including a pair of concave edges on opposite sides thereof.

4. The device of claim 1, wherein the entry portion is more flexible than the body portion of the at least one grommet.

5. The device of claim 1, wherein the at least one aperture comprises a first aperture and a second aperture.

6. The device of claim 5, wherein the first aperture is larger than the second aperture.

7. The device of claim 1, wherein the body portion of the at least one grommet includes a closed endwall on the opposite side of the cavity from the at least one aperture.

8. The device of claim 1, wherein the entry portion includes a plurality of finger portions defining the at least one aperture.

9. The device of claim 1, wherein the at least one aperture has a keyhole shape.

10. The device of claim 1, wherein the at least one aperture has a circular shape.

11. The device of claim 1 further comprising a slot in an outer edge of the main body.

12. The device of claim 1, wherein the main body has a generally flat shape and is generally rigid.

13. The device of claim 1, wherein the main body and at least one grommet are integrally formed.

14. The device of claim 1 further comprising an ornamentation portion on the main body.

15. The device of claim 1, wherein:
the main body comprises a generally planar body portion having a longitudinal axis, upper and lower peripheral edges, and a pair of lateral peripheral edges, wherein the lateral peripheral edges are symmetrically disposed on opposite sides of the longitudinal axis,
a first grommet and a second grommet disposed on opposite sides of the longitudinal axis, wherein the first and second grommets are symmetrical about the longitudinal axis; and
first and second cavities defined by the first and second grommets, respectively;
wherein the upper and lower peripheral edges each have a concave shape.

16. The device of claim 15, wherein the lateral peripheral edges have a convex shape.

17. The device of claim 15, wherein the upper and lower peripheral edges each define a slot portion extending into the body portion.

18. The device of claim 17, wherein the slot portions are disposed on the same side of the longitudinal axis.

19. The device of claim 15, wherein the body portion has four main corners, and the body portion further defines a hole extending therethrough at one or more of the corners.

20. The device of claim 15, wherein the grommets each include a plurality of finger portions that define an aperture of the each of the cavities.
